(19) United States
(12) Patent Application Publication
(10) Pub. No.: US 2024/0311131 A1
(43) Pub. Date: Sep. 19, 2024

(54) VEHICLE INFORMATION PROCESSING DEVICE AND STORAGE MEDIUM

(71) Applicant: TOYOTA JIDOSHA KABUSHIKI KAISHA, Toyota-shi (JP)

(72) Inventors: Tomoaki MIYAZAWA, Nagoya-shi (JP); Ryota Nakabayashi, Nagoya-shi (JP); Naoki Yomoda, Toyota-shi (JP); Atsushi Mori, Miyoshi-shi (JP); Hiroshi Inoue, Nagoya-shi (JP); Tsukasa Kitazawa, Toyota-shi (JP)

(73) Assignee: TOYOTA JIDOSHA KABUSHIKI KAISHA, Toyota-shi (JP)

(21) Appl. No.: 18/589,474

(22) Filed: Feb. 28, 2024

(30) Foreign Application Priority Data
Mar. 13, 2023 (JP) 2023-038708

(51) Int. Cl. G06F 8/65

(52) U.S. Cl. CPC G06F 8/65

(57) ABSTRACT

A vehicle information processing device includes a processor. The processor performs download by receiving update software for an electronic control device mounted on a vehicle. The processor performs installation by causing the electronic control device to store the downloaded update software. The processor performs activation by validating the installed update software. The processor makes a notification of which stage among the download, the installation, and the activation a trouble has occurred in when update to the update software is not successfully completed. The update to the update software is completed when all of the download, the installation, and the activation are completed.

### CROSS-REFERENCE TO RELATED APPLICATION

This application claims priority to Japanese Patent Application No. 2023-038708 filed on Mar. 13, 2023, incorporated herein by reference in its entirety.

### BACKGROUND

### 1. Technical Field

The present disclosure relates to a vehicle information processing device and a storage medium.

### 2. Description of Related Art

A vehicle disclosed in Japanese Unexamined Patent Application Publication No. 2021-105923 (JP 2021-105923 A) includes an electronic control device and an information processing device that manages update of software for the electronic control device. The information processing device is capable of wireless communication with a server. When update software for the electronic control device exists in the server, the information processing device updates the electronic control device to the update software. The update to the update software includes three stages. A first stage includes the information processing device downloading the update software from the server. A second stage includes installing the update software in the electronic control device. A third stage includes activation to validate the installed update software.

As described in JP 2021-105923 A, update to update software in a vehicle occasionally fails. If a user of the vehicle cannot obtain any information that provides a clue as to the reason for the failure in the update at this time, the user may attempt update to the update software again without resolving the cause of the failure, which is not preferable.

### SUMMARY

An aspect of the present disclosure provides a vehicle information processing device including a processor. The processor is configured to perform download by receiving update software for an electronic control device mounted on a vehicle. The processor is configured to perform installation by causing the electronic control device to store the update software. The processor is configured to perform activation by validating the update software. The processor is configured to make a notification of which stage among the download, the installation, and the activation a trouble has occurred in when update to the update software is not successfully completed. The update to the update software is completed when all of the download, the installation, and the activation are completed.

Another aspect of the present disclosure provides a non-transitory storage medium storing instructions. The instructions are executable by one or more processors of a vehicle including an electronic control device and the one or more processors which controls update of software for the electronic control device. The instructions cause the one or more processors to perform functions. The functions include: performing download by receiving update software for the electronic control device; performing installation by causing the electronic control device to store the update software; performing activation by validating the update software; and making a notification of which stage among the download, the installation, and the activation a trouble has occurred in when update to the update software is not successfully completed. The update to the update software is completed when all of the download, the installation, and the activation are completed.

According to the technical ideas described above, it is possible to facilitate grasping the reason for a failure in update to update software.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating a schematic configuration of a vehicle;

FIG. 2 is a flowchart illustrating a process procedure of a notification process;

FIG. 3 is a sequence diagram illustrating the flow of software update;

FIG. 4 illustrates an example of a first image for failure;

FIG. 5 illustrates an example of a second image for failure;

FIG. 6 is a sequence diagram illustrating a modification of a timing to perform the notification process; and

FIG. 7 illustrates an example of a summary image.

### DETAILED DESCRIPTION OF EMBODIMENTS

A vehicle information processing device according to an embodiment will be described below with reference to the drawings.

### Schematic Configuration of Vehicle

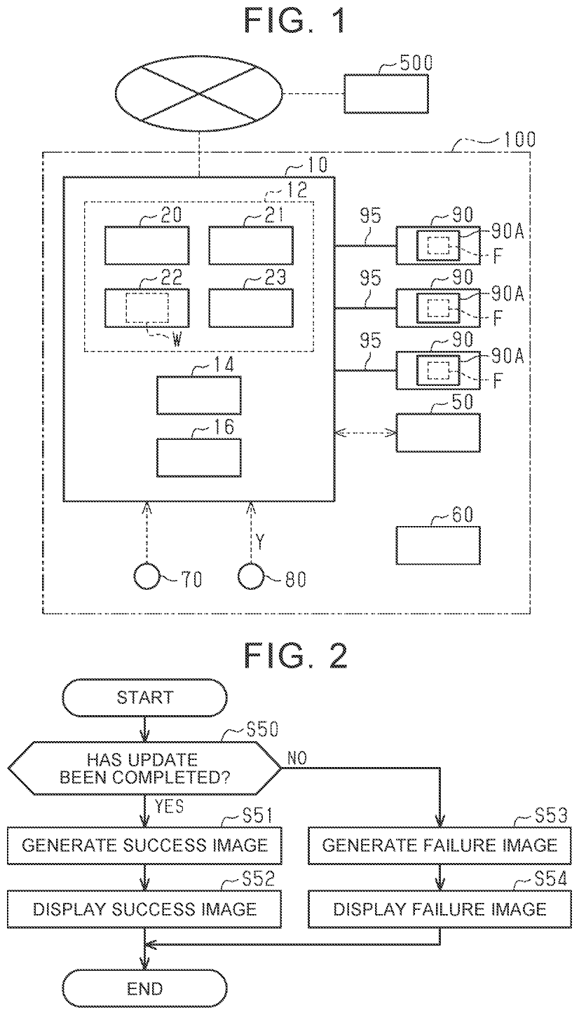

As illustrated in FIG. 1, a vehicle 100 includes an over-the-air (OTA) master 10. The OTA master 10 includes a processing circuit 12. The processing circuit 12 includes a central processing unit (CPU) 20, a first memory 21, a second memory 22, and a third memory 23. The first memory 21 is a non-volatile storage medium. The first memory 21 is electrically rewritable. The first memory 21 functions as a storage that stores data received from the outside, for example. The second memory 22 is a non-volatile storage medium. The second memory 22 is electrically rewritable. The second memory 22 stores software. The software is a group of various programs W that describe processes to be executed by the CPU 20 and various data required for the CPU 20 to execute the programs W. The third memory 23 is a volatile storage medium. The OTA master 10 includes a communication module 14. The communication module 14 is a communication circuit for wireless communication with the outside via an external communication line network. The OTA master 10 includes a real-time clock 16. The real-time clock 16 is a circuit that generates date and time information. The OTA master 10 is an information processing device mounted on the vehicle 100. The OTA master 10 is also an electronic control device mounted on the vehicle 100.

The vehicle 100 includes a plurality of specific control devices 90. In FIG. 1, three of the specific control devices 90 are illustrated as representatives. The specific control devices 90 are each an electronic control device that controls a specific one of a plurality of in-vehicle devices. One of the in-vehicle devices is an engine as a drive source of the vehicle 100. Another of the in-vehicle devices is a hydraulic brake device. Thus, examples of the specific control devices 90 described above include an engine electronic control unit (ECU) and a brake ECU. Other examples of the in-vehicle devices include an air-conditioning device, a meter display device, a car navigation device, an audio device, and a blinker device. Unique identifier values are allocated in advance to the specific control devices 90. The specific control devices 90 can communicate with the OTA master 10 via respective buses 95.

The specific control devices 90 each include a processing circuit that is similar to the OTA master 10. That is, the specific control devices 90 each include a CPU, a non-volatile first memory, a non-volatile second memory 90A, and a volatile third memory. The second memory 90A stores software F for controlling a target in-vehicle device. The non-volatile memories adopted in the present embodiment, including those of the OTA master 10, are of a double-bank structure. The memories of the double-bank structure include two storage areas. This allows writing data into one of the storage areas while reading data from the other storage area.

The vehicle 100 includes a display 50. The display 50 is positioned in a vehicle cabin of the vehicle 100. The display 50 includes a drive circuit and a display screen. The display 50 is connected to the OTA master 10. The display 50 displays an image that matches an instruction signal transmitted by the CPU 20 of the OTA master 10 on the display screen. The display 50 is a touch panel type. That is, when a user performs an input operation on the display screen of the display 50, the display 50 transmits a signal that matches the input operation to the OTA master 10.

The vehicle 100 includes a battery 60. The battery 60 supplies power to various in-vehicle devices such as the OTA master 10, the specific control devices 90, and the display 50, for example.

The vehicle 100 includes a battery sensor 80. The battery sensor 80 detects battery information Y such as temperature, voltage, and current of the battery 60.

The vehicle 100 includes an ignition switch 70. The ignition switch 70 is occasionally referred to as a start switch or a system activation switch. The ignition switch 70 is a switch for a user to provide an instruction to activate the vehicle 100. A system of the vehicle 100 is turned on and off when the user performs an operation to turn on and off the ignition switch 70. In a state in which the system of the vehicle 100 is turned on, the OTA master 10 and the specific control devices 90 are activated. The state in which the system of the vehicle 100 is turned on includes a state in which the vehicle 100 can travel and a so-called accessory-on state. In the accessory-on state, the vehicle 100 cannot travel, but some of the in-vehicle devices can be used. In a state in which the system of the vehicle 100 is turned off, on the other hand, the OTA master 10 and the specific control devices 90 are deactivated. However, the OTA master 10 and the specific control devices 90 are activated by receiving power supply from the battery 60 when it is necessary to perform a process, such as when software is to be updated, for example, even when the system of the vehicle 100 is turned off. The OTA master 10 receives a signal that indicates the state of the vehicle 100 that matches an operation to turn on and off the ignition switch 70. This allows the OTA master 10 to grasp whether the system of the vehicle 100 is turned on or off.

### OTA Server

An OTA server 500 is a management server provided outside the vehicle 100. The OTA server 500 manages information on software for a plurality of vehicles registered in advance. The OTA server 500 stores the latest software that is applicable to each of the vehicles according to the vehicle model and type, for example. The OTA server 500 notifies each vehicle of the presence or absence of new update software that is applicable to the vehicle and transmits the new update software to the target vehicle in response to a request from the vehicle.

### Overview of Functions of Ota Master

The OTA master 10 controls update of software for the specific control devices 90, and makes a notification of the result of the update. This will be described below. The CPU 20 of the OTA master 10 implements processes to be described below by executing the programs W stored in the second memory 22.

The OTA master 10 can execute a preliminary process L. The preliminary process L is a process for the OTA master 10 to grasp whether it is necessary to update software for the specific control devices 90. In the preliminary process L, the OTA master 10 checks the existence of new update software through exchange of information with the OTA server 500.

The OTA master 10 can execute a software update process. The software update process is a process for updating software for the specific control devices 90 to update software. In the software update process, the OTA master 10 updates software for the specific control devices 90 using wireless communication. A technique of updating software using wireless communication is occasionally referred to as “Over The Air (OTA)”.

Update to update software includes three processes. The three processes include download, installation, and activation. The download includes the OTA master 10 receiving update software for a specific control device 90 mounted on the vehicle 100 and storing the received update software in the first memory 21. The installation includes the OTA master 10 causing the specific control device 90 as the update target to store the update software obtained through the download. The activation includes the OTA master 10 validating the installed update software for the specific control device 90 as the update target. Specifically, the activation includes changing the content of settings of the specific control device 90, in order to change the software to be read by the specific control device 90 when performing various processes from current software to the update software. For example, the OTA master 10 changes the setting of a read flag in the specific control device 90 in the activation. The read flag is a flag that specifies a target storage area when reading software. By changing the setting of the read flag, the specific control device 90 switches the storage area from which software is read from a storage area in which the current software is stored to a storage area in which the update software is stored.

The OTA master 10 implements update to update software through three processes including a first process M1, a second process M2, and a third process M3. That is, the software update process includes the three processes including the first process M1, the second process M2, and the third process M3. The first process M1 is a process for downloading update software. The first process M1 includes, in addition to download itself, a first preliminary determination to determine whether a condition for executing download is met, a first verification to verify the downloaded update software, etc. The first verification is a vehicle compatibility verification to determine whether the update software is compatible with the vehicle 100. The first preliminary determination includes a first capacity determination to determine the presence or absence of a shortage in the storage capacity necessary for download, and a first battery determination to determine the state of the battery 60 in the stage of performing download. The OTA master 10 can calculate a charge rate that is the ratio of the remaining capacity to the full charge capacity of the battery 60 based on the battery information Y detected by the battery sensor 80. The OTA master 10 makes the first battery determination by referencing the charge rate. The same applies to a second battery determination and a third battery determination to be discussed later.

The second process M2 is a process for installing the update software. The second process M2 includes, in addition to installation itself, a second preliminary determination to determine whether a condition for executing installation is met, a second verification to verify the installed update software, etc. The second verification is a type of the vehicle compatibility verification described above. The second preliminary determination includes a second capacity determination to determine the presence or absence of a shortage in the storage capacity necessary for installation, and a second battery determination to determine the state of the battery 60 in the stage of performing installation. Regarding the installation and the second verification performed in the second process M2, the OTA master 10 transmits an instruction signal for performing the installation and the second verification to the specific control device 90. The specific control device 90 performs various processes, as instructed, in response to this instruction signal. Since the OTA master 10 provides an instruction for the installation and the second verification, the OTA master 10 is the control subject that performs the installation and the second verification. That is, the OTA master 10 performs the installation and the second verification.

The third process M3 is a process for activating the installed update software. The third process M3 includes, in addition to activation itself, a third preliminary determination to determine whether a condition for executing activation is met, a process of checking setting information after the activation, etc. The third preliminary determination according to the present embodiment is a third battery determination to determine the state of the battery 60 in the stage of performing activation. Regarding the activation performed in the third process M3, the OTA master 10 transmits an instruction signal for performing the activation to the specific control device 90. The specific control device 90 performs a process, as instructed, in response to this instruction signal. Since the OTA master 10 provides an instruction for the activation, the OTA master 10 is the control subject that performs the activation. That is, the OTA master 10 performs the activation.

The OTA master 10 can execute a notification process P. Completion of all of the download, the installation, and the activation is referred to as completion of the update to the update software. In the notification process P, the OTA master 10 makes a completion determination to determine whether the update to the update software has been successfully completed. When the update to the update software has not been successfully completed, the OTA master 10 makes a failure notification that a failure has occurred in the update. The failure notification includes information that indicates which of the download, the installation, and the activation a trouble has occurred in, that is, the stage in which a failure has occurred in the update. This information is specifically an error code allocated in advance to each of the download, the installation, and the activation. In the present embodiment, the error code of the download is “1”. The error code of the installation is “2”. The error code of the activation is “3”. The failure notification also includes the following content. That is, the failure notification includes the results of the first verification and the second verification. The failure notification includes the state of the battery 60 in the stage in which a failure has occurred in the update. The failure notification includes the results of the first capacity determination and the second capacity determination. The failure notification includes information that indicates the specific control device 90 for which the update has not been successfully completed. This information is specifically the name of an in-vehicle device as the target to be controlled by the specific control device 90 for which the update has not been successfully completed.

### Flow of Software Update

The flow of a series of processes for updating software for the specific control device 90 will be described.

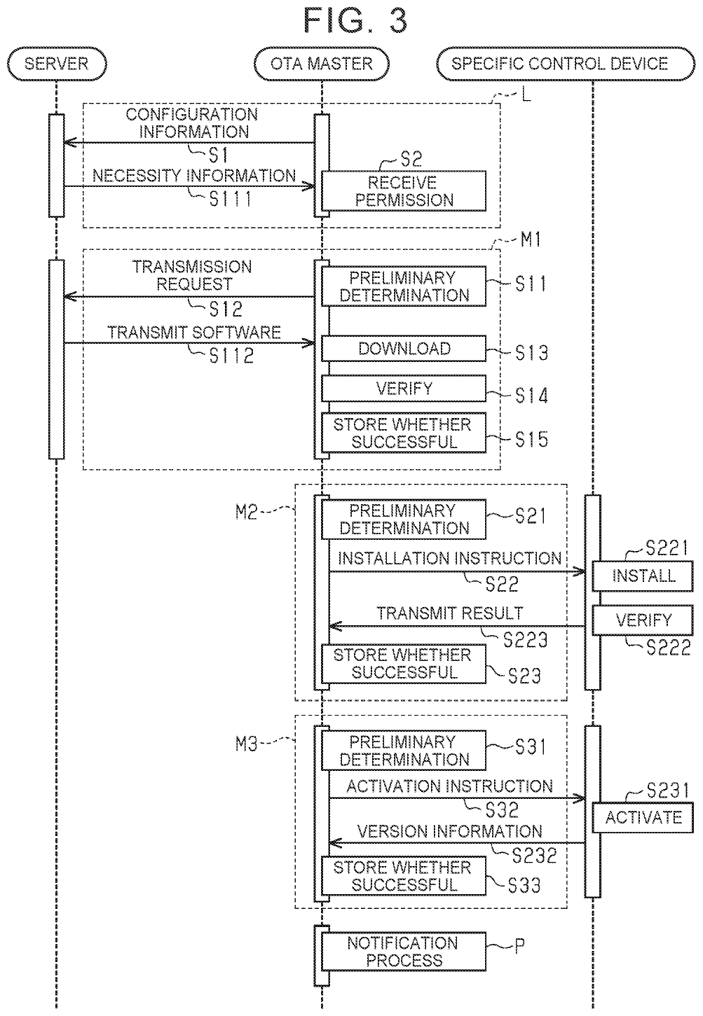

The OTA master 10 performs the preliminary process L when the system of the vehicle 100 is switched from off to on. As illustrated in FIG. 3, the OTA master 10 first performs the process in step S1 in the preliminary process L. In step S1, the OTA master 10 transmits an identifier value allocated to the vehicle 100 and configuration information on the vehicle 100 to the OTA server 500. The configuration information is a table in which the respective identifier values of the specific control devices 90 mounted on the vehicle 100 and version information on the current software for the specific control devices 90 are correlated with each other. The first memory 21 of the OTA master 10 stores the configuration information.

When the configuration information is received from the vehicle 100, the OTA server 500 determines whether there exists new update software that is applicable to the vehicle 100 based on the configuration information on the vehicle 100. In step S111, the OTA server 500 transmits update necessity information that indicates the determination result to the vehicle 100.

When the update necessity information is received, the OTA master 10 performs the process in step S2. When there exists new update software in step S2, the OTA master 10 causes the display 50 to display a notification that inquires whether update to the update software is allowed. When a user permits update to the update software in response to this notification, the OTA master 10 transitions to the software update process to be described below. When there does not exists new update software or when a permission from the user cannot be obtained in step S2, the OTA master 10 cancels the execution of the software update process. The above processes in steps S1 and S2 constitute the preliminary process L.

### First Process

When the OTA master 10 transitions to the software update process, the OTA master 10 first performs the first process M1. The first process M1 is basically performed in a situation in which the system of the vehicle 100 is turned on. The system of the vehicle 100 may be switched from on to off in the middle of the execution of the first process M1, depending on the situation of use of the vehicle 100 by the user.

In the first process M1, the OTA master 10 first performs the process in step S11. In S11, the OTA master 10 makes a first preliminary determination to determine whether a condition for executing download is met. The execution condition is met when two items including a first item that there is no shortage in the charge rate of the battery 60 and a second item that there is no shortage in the storage capacity necessary for download are met. The OTA master 10 makes a first battery determination to grasp whether the first item is met. In the first battery determination, the OTA master 10 determines whether the current charge rate of the battery 60 is equal to or more than a predetermined charge rate. The predetermined charge rate is determined in advance as a value that provides a margin enough for the charge rate of the battery 60. The OTA master 10 makes a first capacity determination to grasp whether the second item is met. In the first capacity determination, the OTA master 10 determines whether the current free capacity of the first memory 21 is equal to or more than a predetermined capacity. The free capacity here is the free capacity in a storage area of the first memory 21 that is available for the software update process. The predetermined capacity is determined in advance as a capacity that allows the first memory 21 to store update software even when the data volume of the update software is large to a certain degree. When the execution condition is met as a result of performing the first battery determination and the first capacity determination, the OTA master 10 performs the process in step S12. When the execution condition is not met in the first preliminary determination, the OTA master 10 skips the processes in steps S12, S13, and S14 to be described later and performs the process in step S15.

In step S12, the OTA master 10 requests the OTA server 500 to transmit update software. In step S112, the OTA server 500 transmits update software that is applicable to the vehicle 100 to the vehicle 100 in response to this transmission request. Then, the OTA master 10 performs the process in step S13. That is, the OTA master 10 downloads the update software in step S13. Specifically, the OTA master 10 receives the update software transmitted from the OTA server 500, and stores the received update software in the first memory 21. An event in which download must inevitably be interrupted for some reason in the middle of the execution of the download may occur in the OTA master 10. In this case, the OTA master 10 interrupts the download in the middle, and skips the process in step S14 to be described later. When the download is completed, on the other hand, the OTA master 10 performs the process in step S14. In the present embodiment, the following processes will be described using a case where one piece of update software is downloaded, that is, there is one specific control device 90 as the update target.

In step S14, the OTA master 10 performs a first verification for the downloaded update software. Here, the update software includes, in addition to main information such as program codes, an identifier value of the specific control device 90 as the update target and version information on the update software. In the first verification, the OTA master 10 checks the content of the update software from the following two viewpoints. A first viewpoint is whether the specific control device 90 as the target for the received update software is the specific control device 90 actually mounted on the vehicle 100. A second viewpoint is whether the version of the received update software is newer than that of the software currently stored in the specific control device 90. In the first verification, the OTA master 10 determines whether the update software is appropriate from these two viewpoints. The OTA master 10 determines the result of the first verification as passing if the update software is appropriate, and determines the result of the first verification as failing if the update software is inappropriate. When the first verification is performed, the OTA master 10 proceeds to the process in step S15.

In step S15, the OTA master 10 makes a download determination to determine whether the download is successful. In the download determination, the OTA master 10 determines that the download is successful when the result of the first verification is passing. On the other hand, the OTA master 10 determines that a failure has occurred in the download in any of the following three cases. A first of the three cases is a case where the result of the first verification is failing. A second of the three cases is a case where the download has not been successfully completed for any reason in step S13. A third of the three cases is a case where the execution condition is not met in the first preliminary determination in step S11. When the download determination is made as described above, the OTA master 10 generates update result information. The update result information includes an identifier value of the specific control device 90 as the update target, the current date and time, and the result of the download determination. The OTA master 10 stores the update result information in the first memory 21. When it is determined that a failure has occurred in the download, the OTA master 10 also writes the result of the first battery determination, the result of the first capacity determination, the result of the first verification, etc. into the update result information. The OTA master 10 stores whether the download determination is successful, the verification result, etc. using a unique identifier value. The determination results etc. are stored using a unique identifier value also in the second process M2 and the third process M3 to be discussed later, although not described fully. The above processes in steps S11, S12, S13, S14, and S15 constitute the first process M1.

### Second Process

When it is determined that the download is successful in the download determination in the first process M1, the OTA master 10 performs the second process M2 subsequent to the first process M1. When it is determined that a failure has occurred in the download in the download determination, the OTA master 10 cancels the second process M2 and the third process M3. In this case, the OTA master 10 performs the notification process P at a timing to be discussed later.

In the second process M2, the OTA master 10 first performs the process in step S21. In step S21, the OTA master 10 makes a second preliminary determination to determine whether a condition for executing installation is met. The execution condition is met when two items including a first item that there is no shortage in the charge rate of the battery 60 and a second item that there is no shortage in the storage capacity necessary for installation are met. The OTA master 10 makes a second battery determination to grasp whether the first item is met. In the second battery determination, as in the first battery determination, the OTA master 10 determines whether the current charge rate of the battery 60 is equal to or more than a predetermined charge rate. The OTA master 10 makes a second capacity determination to grasp whether the second item is met. In the second capacity determination, the OTA master 10 determines whether the free capacity of the second memory 90A of the specific control device 90 as the update target is equal to or more than the data volume of the update software. Prior to making the second capacity determination, the OTA master 10 requests the specific control device 90 as the update target to transmit the current memory state. In response to this request, the specific control device 90 as the update target transmits information on the free capacity of the second memory 90A to the OTA master 10. This free capacity is the free capacity in a storage area of the second memory 90A that is available to store new software. When the execution condition is met as a result of making the second battery determination and the second capacity determination, the OTA master 10 performs the process in step S22. When the execution condition is not met in the second preliminary determination, the OTA master 10 skips the process in step S22 to be described later and performs the process in step S23.

In step S22, the OTA master 10 transmits, to the specific control device 90 as the update target, update software for the specific control device 90 and an installation instruction signal. The installation instruction signal is a signal for instructing the specific control device 90 to store the update software in the second memory 90A of the specific control device 90, verify the stored update software, and transmit the verification result to the OTA master 10.

When the update software and the installation instruction signal are received, the specific control device 90 as the update target performs the process in step S221. In step s221, the specific control device 90 installs the update software. That is, the specific control device 90 stores the update software in the second memory 90A of the specific control device 90 itself. The specific control device 90 stores the update software in a storage area that is different from a storage area for software that is currently used. After that, the specific control device 90 performs a second verification about the installed update software in step S222. In the second verification, the specific control device 90 checks whether the content of the update software is free from a falsification or an error. After that, the specific control device 90 as the update target performs the process in step S223. In step S223, the specific control device 90 transmits the result of the second verification to the OTA master 10 together with the identifier value of the specific control device 90 itself. The result of the second verification is passing if the update software is appropriate, and failing otherwise. An event in which installation of the update software must inevitably be interrupted for some reason in the middle of the execution of the installation may occur in the specific control device 90. In this case, the specific control device 90 does not perform the second verification. In this case, in step S223, the specific control device 90 transmits an interruption result indicating that the installation has been interrupted in the middle to the OTA master 10 together with the identifier value of the specific control device 90 itself.

After that, in step S23, the OTA master 10 makes an installation determination to determine whether the installation is successful. In the installation determination, the OTA master 10 determines that the installation is successful when the result of the second verification is passing. On the other hand, the OTA master 10 determines that a failure has occurred in the installation in any of the following three cases. A first of the three cases is a case where the result of the second verification is failing. A second of the three cases is a case where the installation interruption result is received from the specific control device 90. A third of the three cases is a case where the execution condition is not met in the second preliminary determination in step S21. When the installation determination is made, the OTA master 10 writes the determination result into the update result information. When a failure has occurred in the installation, the OTA master 10 also writes the result of the second battery determination, the result of the second capacity determination, the result of the second verification, etc. into the update result information. The above processes in steps S21, S22, and S23 constitute the second process M2.

### Third Process

When it is determined that the installation is successful in the installation determination in the second process M2, the OTA master 10 performs the third process M3. When the system of the vehicle 100 is turned on when the second process M2 is ended, the OTA master 10 stands by to execute the third process M3 until the system of the vehicle 100 is turned off. The OTA master 10 executes the third process M3 when the system of the vehicle 100 is switched from on to off. When the system of the vehicle 100 is turned off at the time when the second process M2 is ended, on the other hand, the OTA master 10 performs the third process M3 subsequent to the second process M2. When the user performs an operation to turn on the ignition switch 70 during execution of the third process M3, the OTA master 10 causes the display 50 to display the following message. The message says that the system of the vehicle 100 cannot be turned on since software update is being executed. When the OTA master 10 causes the display 50 to display this message, switching of the system of the vehicle 100 from off to on is suspended. When it is determined that a failure has occurred in the installation in the installation determination, the OTA master 10 cancels the third process M3. In this case, the OTA master 10 performs the notification process P at a timing to be discussed later.

In the third process M3, the OTA master 10 first performs the process in step S31. In step S31, the OTA master 10 makes a third preliminary determination to determine whether a condition for executing activation is met. The execution condition is met when there is no shortage in the charge rate of the battery 60. In the third preliminary determination, the OTA master 10 makes a third battery determination as to whether the current charge rate of the battery 60 is equal to or more than a predetermined charge rate. When the execution condition is met in the third preliminary determination, the OTA master 10 performs the process in step S32. When the execution condition is not met in the third preliminary determination, the OTA master 10 skips the process in step S32 and performs the process in step S33 to be discussed later.

In step S32, the OTA master 10 transmits an activation instruction signal to the specific control device 90 as the update target. The activation instruction signal is a signal for instructing the specific control device 90 to activate the installed update software and transmit software information after the activation to the OTA master 10. The software information is version information on the software to be read by the specific control device 90.

When the activation instruction signal described above is received, the specific control device 90 as the update target performs the process in step S231. In step S231, the specific control device 90 activates the update software. That is, the specific control device 90 validates the update software. For example, the specific control device 90 makes a change in the setting of the read flag that specifies a storage area from which software is read. When this change in setting is not successfully made, the software to be read from the next time on remains the original software, rather than the newly installed update software. After that, in step S232, the specific control device 90 transmits version information on the software to be read from the next time on to the OTA master 10 together with the identifier value of the specific control device 90. An event in which activation of the update software must inevitably be interrupted for some reason in the middle may occur in the specific control device 90. In this case, in step S232, the specific control device 90 transmits an interruption result indicating that the activation has been interrupted in the middle to the OTA master 10 together with the identifier value of the specific control device 90 itself.

After that, in step S33, the OTA master 10 makes an activation determination to determine whether the activation is successful. In the activation determination, the OTA master 10 references the version information on the software received from the specific control device 90 and the configuration information on the vehicle 100 described in step S1. When the version of the software to be read from the next time on by the specific control device 90 is newer than the content of the configuration information on the vehicle 100, the OTA master 10 determines that the activation is successful. On the other hand, the OTA master 10 determines that a failure has occurred in the activation in any of the following three cases. A first of the three cases is a case where the software to be read from the next time on is not a new version. A second of the three cases is a case where the activation interruption result is received from the specific control device 90. A third of the three cases is a case where the execution condition is not met in the third preliminary determination in step S31. When the activation determination is made, the OTA master 10 writes the determination result into the update result information. When a failure has occurred in the activation, the OTA master 10 also writes the result of the third battery determination into the first memory 21. When the activation is successful, the OTA master 10 updates version information on the software for the specific control device 90 as the update target, in the configuration information on the vehicle 100, to the latest one. The above processes in steps S31, S32, and S33 constitute the third process M3.

### Notification Process

The OTA master 10 executes the notification process P when the system of the vehicle 100 is switched from off to on for the first time after the software update process is finished. As described above, the software update process includes the three processes including the first process M1, the second process M2, and the third process M3. It depends on the situation which of the three processes the software update process is ended in. For example, the OTA master 10 occasionally ends the software update process at the time when the first process M1 is finished. In this case, the OTA master 10 performs the notification process P when the system of the vehicle 100 is switched from off to on for the first time after the first process M1 is ended. Alternatively, the OTA master 10 occasionally ends the software update process at the time when the first process M1 and the second process M2 are finished. In this case, the OTA master 10 performs the notification process P when the system of the vehicle 100 is switched from off to on for the first time after the second process M2 is ended.

As illustrated in FIG. 2, the OTA master 10 first executes the process in step S50 when the notification process P is started. In step S50, the OTA master 10 makes a completion determination whether the update to the update software has been successfully completed. As described above, the update to the update software has been completed when all of the download, the installation, and the activation have been completed. The OTA master 10 references the update result information. Then, the OTA master 10 makes a completion determination in consideration of the results of the download determination, the installation determination, and the activation determination. When there exists a result of the activation determination and the result is successful, the OTA master 10 determines that the update to the update software has been successfully completed. In this case (step S50: YES), the OTA master 10 proceeds to the process in step S51.

In step S51, the OTA master 10 generates a success image. Although not illustrated, this image includes the following three display contents. A first display content is a message saying that software update has been completed. A second display content is the name of an in-vehicle device as the target to be controlled by the specific control device 90 as the update target. A third display content is an end button. The end button is an input button that allows the user to provide an instruction to end display of the success image. Regarding the second display content, the OTA master 10 specifies the name of an in-vehicle device as follows. As a precondition, the second memory 22 of the OTA master 10 stores a control item list. The control item list is a table in which the respective identifier values of the specific control devices 90 and the names of in-vehicle devices to be controlled by the specific control devices 90 are correlated with each other. The OTA master 10 specifies the name of an in-vehicle device using the control item list. Specifically, the OTA master 10 first reads the identifier value of a specific control device 90 as the update target from the update result information. Then, the OTA master 10 specifies the name of an in-vehicle device to be controlled by the specific control device 90 based on the control item list. When a success image is generated, the OTA master 10 proceeds to the process in step S52.

In step S52, the OTA master 10 transmits an instruction signal for displaying the success image to the display 50. In response to this instruction signal, the display 50 displays the success image. After that, the OTA master 10 causes the display 50 to end display of the success image when the user operates the end button. At the same time, the OTA master 10 ends the process in step S52. Then, the OTA master 10 ends the notification process P.

In step S50, on the other hand, the OTA master 10 determines that the update to the update software has not been successfully completed, that is, a failure has occurred in the update to the update software, when any of the following three cases applies. A first case is a case where the result of the download determination indicates a failure. A second case is a case where the result of the installation determination indicates a failure. A third case is a case where the result of the activation determination indicates a failure. When it is determined that a failure has occurred in the update to the update software (step S50: NO), the OTA master 10 proceeds to the process in step S53.

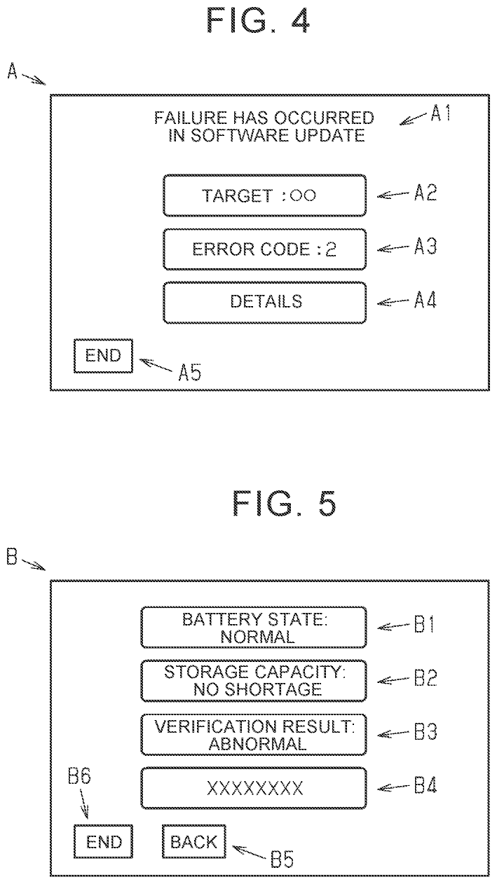

In step S53, the OTA master 10 generates a failure image. The failure image includes two images including a first image A and a second image B. The OTA master 10 first generates a first image A. As illustrated in FIG. 4, the first image A includes a plurality of display contents. A first display content A1 is a message saying that a failure has occurred in the software update. A second display content A2 is the name of an in-vehicle device as the target to be controlled by the specific control device 90 as the update target. The OTA master 10 specifies the name of an in-vehicle device based on the control item list and the update result information, as when generating a success image. A third display content A3 is an error code that indicates the stage in which a failure has occurred in the update to the update software. In FIG. 4, an error code of “2” is given as an example of a case where a failure has occurred in the installation. The OTA master 10 specifies the stage in which a failure has occurred in the update based on the update result information. A fourth display content A4 is a details button. The details button is an input button that allows the user to provide an instruction to display the second image B to be described later. A fifth display content A5 is an end button. The end button is an input button that allows the user to provide an instruction to end display of the first image A.

When generation of the first image A is finished, the OTA master 10 generates a second image B. As illustrated in FIG. 5, the second image B is an image for displaying detailed information on the failure in the update. The second image B includes the following plurality of display contents. A first display content B1 is the state of the battery 60 in the stage in which a failure has occurred in the update. The OTA master 10 has the result of the battery determination in each stage reflected in the first display content B1. For example, when a failure has occurred in the stage of the installation, the OTA master 10 has the result of the second battery determination reflected in the first display content B1. When the result of the second battery determination is positive, the OTA master 10 treats the battery information as normal. When the result of the second battery determination is negative, on the other hand, the OTA master 10 treats the battery information as abnormal. A second display content B2 is the result of the capacity determination in the stage in which a failure has occurred in the update. The OTA master 10 has the result of the capacity determination in each stage reflected in the second display content B2. When the result of the capacity determination is positive, the OTA master 10 determines that there is no shortage in the storage capacity necessary for update to the update software. When the result of the capacity determination is negative, on the other hand, the OTA master 10 determines that there is a shortage in the storage capacity necessary for update to the update software. There is no second display content B2 when the stage in which a failure has occurred is the activation. A third display content B3 is the result of the verification in the stage in which a failure has occurred in the update. The OTA master 10 has the result of the verification in the stage in which a failure has occurred in the update reflected in the third display content B3. If the result of the verification is passing, the OTA master 10 determines that the update software is not abnormal. If the result of the verification is failing, on the other hand, the OTA master 10 determines that the update software is abnormal. There is no third display content B3 when the stage in which a failure has occurred is the activation. There is no third display content B3 when no verification has been performed, even when the stage in which a failure has occurred is the download or the installation. A fourth display content B4 is a message about a recommended future action. The fourth display content B4 is a message that provides guidance on taking the vehicle to a maintenance factory or retrying the update. The OTA master 10 selects what guidance to provide based on the various determination results etc. in the update result information. A fifth display content B5 is a back button. The back button is an input button that allows the user to provide an instruction to return from the second image B to the first image A. A sixth display content B6 is an end button. The end button is an input button that allows the user to provide an instruction to end display of the failure screen itself. As illustrated in FIG. 2, when the first image A and the second image B are generated, the OTA master 10 proceeds to the process in step S54.

In step S54, the OTA master 10 transmits an instruction signal for displaying various failure images to the display 50. The display 50 displays a failure image in response to this instruction signal. At the time when the process proceeds to step S54, the OTA master 10 causes the display 50 to display the first image A for failure. After that, the OTA master 10 switches the content to be displayed on the display 50 between the first image A and the second image B in response to an input operation performed by the user on the display 50. Causing the display 50 to display the first image A or the second image B corresponds to making a failure notification. When the user operates an end button in either image, the OTA master 10 causes the display 50 to end the display of the failure image. At the same time, the OTA master 10 ends the process in step S54. Then, the OTA master 10 ends the notification process P.

Regarding the timing to end step S54, the OTA master 10 may cause the display 50 to display a failure image and end the display of the failure image a certain time determined in advance thereafter. The OTA master 10 may end the process in step S54 at the same time. The same applies to step S52.

The flow of the series of processes for updating software have been described above. Here, the OTA master 10 is set so as to keep storing the update result information, without overwriting the update result information, until a reset signal determined in advance is received. The OTA master 10 is set to be able to redisplay various failure images in response to an input operation performed through the display 50. Thus, a worker at a maintenance factory can recheck the various failure images when the user takes the vehicle 100 to the maintenance factory when a failure has occurred in the software update, for example.

### Functions of Embodiment

It is now assumed that the OTA master 10 has performed the software update process. It is then assumed that, in the second process M2, the installation is executed (step S221) and thereafter the second verification has failed (step S222). In this case, the OTA master 10 causes the display 50 to display the first image A for failure illustrated in FIG. 4 in the notification process P. When the user operates the details button, the OTA master 10 causes the display 50 to display the second image B for failure illustrated in FIG. 5.

### Effects of Embodiment

(1) As described above, the second image B for failure according to the present embodiment includes the battery information in the stage in which a failure has occurred in the software update, the presence or absence of a shortage in the storage capacity, and the verification result. Such information is very useful in grasping the reason for the failure in the update. However, the reason for the failure in the update may not be found from only such information. In the software update process, as described above, download and installation may be suspended for some reason. In such cases, the reason for the failure may not be grasped from only the content of the second image B.

In the present embodiment, in this respect, the first image A for failure includes information on the stage in which a failure has occurred in the update. Here, when updating software, the reason for failures that occur in each stage is roughly determined. Therefore, the reason for a failure that has occurred in the update can be roughly, if not exactly, estimated based on the stage in which the failure has occurred. For example, if a failure has occurred in the activation, it can be estimated that it is highly possible that a change in setting of the read flag was not made appropriately. Thus, the user of the vehicle 100 or a worker at a maintenance factory can easily grasp the reason for a failure in the update by including information on the stage in which the failure has occurred in the update in the first image A.

(2) The first image A for failure includes the name of an in-vehicle device to be controlled by the specific control device 90 for which a failure has occurred in the update. That is, the specific control device 90 for which a failure has occurred in the update can be grasped by looking at the first image A. It is assumed that a failure has occurred in the update for a certain specific control device 90 in the stage of the installation or the activation. In this case, the reason for the failure in the update may be a trouble in the specific control device 90. With the configuration according to the present embodiment, when the failure in the update has occurred in the stage of the installation or the activation, information that indicates accordingly and the specific control device 90 as the target are found. If information on the specific control device 90 as the target can be grasped in addition to the fact that the failure in the update has occurred in the stage of the installation or the activation, the following is enabled. That is, the target to be inspected at a maintenance factory can be easily specified, for example. If the target to be inspected can be specified, the reason for the failure in the update can be grasped considerably easily. In this manner, the configuration according to the present embodiment is significantly effective in grasping the reason for the failure in the update.

(3) A failure occasionally occurs in update to update software because of inappropriateness in update software sent from the OTA server 500, rather than a trouble in the specific control device 90. If there is inappropriate in the update software, it is not necessary to suspect a trouble in the specific control device 90 even when a failure has occurred in the update to the update software.

In the present embodiment, a first verification and a second verification as vehicle compatibility verifications about the update software are performed. Then, the results of the verifications are included in the second image B for failure. This allows the user of the vehicle 100 or a worker at a maintenance factory to grasp a failure having occurred in the update because of inappropriateness in the update software when such a failure has occurred. This eliminates the need to inspect the vehicle 100 unnecessarily.

(4) The second image B according to the present embodiment includes the result of a capacity determination. This allows easily grasping whether the reason for a failure having occurred in the update to the update software is associated with a shortage in the memory capacity when such a failure has occurred. Moreover, as described above, the first image A according to the present embodiment includes information on the stage in which a failure has occurred. Thus, when the reason for the failure in the update is a shortage in the memory capacity, it is possible to easily grasp whether the relevant processing device is the OTA master 10 or the specific control device 90 as the update target.

(5) The second image B according to the present embodiment includes the battery information. This allows easily grasping whether the reason for a failure having occurred in the update to the update software is associated with a shortage in the charge rate of the battery 60 when such a failure has occurred.

(6) An error code is used to display the stage in which a failure has occurred in the update in the first image A according to the present embodiment. The error code is not likely to complicate the display content. Thus, the user or a worker at a maintenance factory can easily grasp the display content.

### Modifications

The above embodiment can be modified as follows. The above embodiment and the following modifications can be combined with each other as long as no technical contradiction arises.

The content of the first capacity determination is not limited to the example according to the above embodiment. For example, the following aspect may be adopted in the first capacity determination. As a precondition, when the OTA server 500 notifies the OTA master 10 of the existence of new update software in step S111, information on the data volume of the update software is included in the content of the notification. In such a case, a comparison may be made between the data volume of the update software and the free capacity of the first memory 21 of the OTA master 10 in the first capacity determination. When the above aspect is adopted in step S111, the following aspect may be adopted in the first capacity determination. That is, a capacity proportion as the proportion of the data volume of the update software to the free capacity of the first memory 21 may be calculated in the first capacity determination. The presence or absence of a shortage in the storage capacity for performing update to the update software can also be grasped by obtaining information on the capacity proportion. In this manner, any process that allows obtaining information that allows grasping the presence or absence of a shortage in the storage capacity for performing update may be treated as the first capacity determination. The same applies to the second capacity determination.

The information that indicates the result of a capacity determination in the failure image is not limited to the example according to the above embodiment. For example, a capacity proportion may be adopted as the information that indicates the result of a capacity determination when a capacity proportion is calculated in a capacity determination as in the above modification. In this manner, the information that indicates the result of a capacity determination may be changed, as appropriate, according to the content of the capacity determination. Further, the information that indicates the result of a capacity determination may not necessarily be the result of the capacity determination itself. For example, when a capacity proportion is calculated in a capacity determination, the information that indicates the result of a capacity determination may be whether there is a shortage in the storage capacity or there is no shortage in the storage capacity based on the value of the capacity proportion. The information that indicates the result of a capacity determination may reflect the result of a capacity determination in any manner.

The content of the first verification is not limited to the example according to the above embodiment. For example, it may be checked in the first verification whether the content of the update software is free from a falsification or an error. That is, the content of the second verification according to the above embodiment may be added to the first verification. Similarly, the content of the second verification is not limited to the example according to the above embodiment. For example, the content of the first verification according to the above embodiment may be added to the second verification. Besides the contents of the first verification and the second verification according to the above embodiment, a content that is necessary to grasp whether the update software is suitable for the vehicle 100 may be verified in the first verification and the second verification. A vehicle compatibility verification as to whether the update software is suitable for the vehicle 100 may be performed by the completion of update to the update software.

The information that indicates the result of a vehicle compatibility verification in a failure image is not limited to the example according to the above embodiment. For example, when it is found in a vehicle compatibility verification that the update software is not suitable for the vehicle 100, the specific content of the vehicle compatibility verification may be used as the information that indicates the result of a vehicle compatibility verification. The information that indicates the result of a vehicle compatibility verification may reflect the result of a vehicle compatibility verification in any manner.

The information that indicates the state of the battery 60 in a failure image is not limited to the example according to the above embodiment. The information that indicates the state of the battery 60 may be the charge rate itself of the battery 60 in the stage in which the first process M1, the second process M2, or the third process M3 is performed. The information that indicates the state of the battery 60 may be the temperature of the battery 60. The information that indicates the state of the battery 60 may reflect the state of the battery 60 in any manner.

The information that indicates the specific control device 90 for which the update has not been successfully completed in a failure image is not limited to the example according to the above embodiment. This information may be a specific name of the specific control device 90 such as an engine ECU or a brake ECU, for example. The information that indicates the specific control device 90 for which the update has not been successfully completed may allow grasping the specific control device 90.

The information that indicates the stage in which a failure has occurred in the update in a failure notification is not limited to the example according to the above embodiment. The information that indicates the stage in which a failure has occurred in the update may be a specific name such as “download”, “installation”, or “activation”, rather than an error code.

It is not essential that the failure image should include the following four display contents. The four display contents include information that indicates the state of the battery 60 in the stage in which a failure has occurred in the update, information that indicates the result of a capacity determination, information that indicates the result of a vehicle compatibility verification, and information that indicates the specific control device 90 for which the update has not been successfully completed. All of these four may be removed from the failure image, or one or more of these may be retained while removing the others. Even without these pieces of information, it is possible to obtain a useful clue as to the reason for a failure in the update if information that indicates the stage in which a failure has occurred in the update is included in the failure image.

The overall configuration of a failure image is not limited to the example according to the above embodiment. For example, the content of the second image B may be included in the first image A according to the above embodiment.

A display content other than those described in relation to the above embodiment may be included in a failure image. For example, when a message that provides guidance on retrying the update is displayed, a setting field for a schedule of the next execution of a series of processes related to the update may be provided. This setting field may be configured to receive a scheduled date and time of input by the user.

The display content of a failure image may include the operation status of the ignition switch 70. Here, in the above embodiment, non-volatile memories of the double-bank structure are used as the non-volatile memories of the specific control devices 90. However, non-volatile memories of a single-bank structure may be adopted as the non-volatile memories of the specific control devices 90. The memories of this type include only a single storage area, unlike those of the double-bank structure. The memories of this type do not allow writing data into the memories when data are being read from the memories. In association with the above, when non-volatile memories of the single-bank structure are adopted, the second process M2 including an installation process is performed on condition that the system of the vehicle 100 is turned off. However, an operation to turn on the ignition switch 70 may be performed in the middle of the execution of the installation although the installation is started when the system of the vehicle 100 is turned off, for example. In this case, the installation process is suspended. In such a case, information indicating that an operation to turn on the ignition switch 70 has been performed during the execution of the installation may be included in the display content of a failure image.

Information about the request to transmit update software in step S12 may be included in the display content of a failure image. Here, regarding step S12 of the first process M1, the OTA master 10 may not be able to receive update software because of a trouble in communication etc., even if the OTA master 10 has requested the OTA server 500 to transmit update software. In this case, the OTA master 10 may repeatedly make a request to transmit update software on condition that the system of the vehicle 100 is turned on, for example. When update software has finally not been successfully received even if a transmission request is repeatedly made in this manner, the OTA master 10 may include the number of requests made for transmission in a failure image.

The overall flow of the software update process is not limited to the example according to the above embodiment. The software update process may be configured such that update to the update software can be performed appropriately. The execution conditions for the download, the installation, and the activation may be changed from the examples according to the above embodiment.

The timings to perform the first process M1, the second process M2, and the third process M3 in the software update process are not limited to the examples according to the above embodiment. The timing to perform the preliminary process L is not limited to the example according to the above embodiment. For example, the preliminary process L may be performed when the system of the vehicle 100 is turned off. The first process M1, the second process M2, and the third process M3 may be performed directly after the preliminary process L is finished. Update to the update software may be performed when the system of the vehicle 100 is turned on, depending on the type of the specific control device 90 as the update target. In such a case, the third process M3 may be performed when the system of the vehicle 100 is turned on.

The timing to perform the notification process P is not limited to the example according to the above embodiment. For example, the notification process P may be performed when the system of the vehicle 100 is turned off if it is found that the user is present in the vehicle cabin of the vehicle 100, for example.

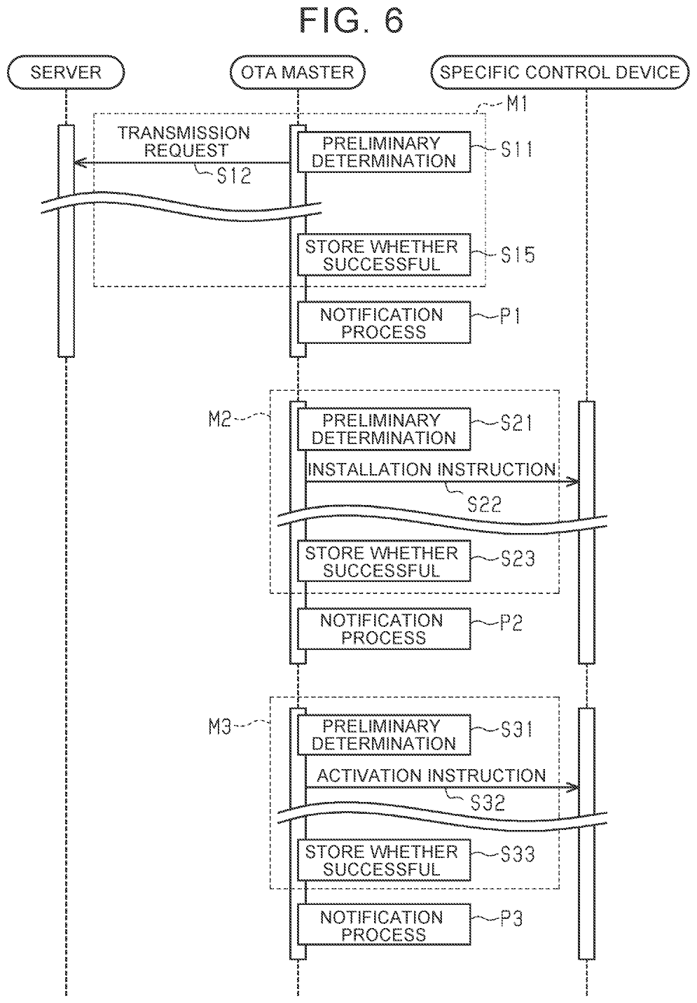

As illustrated in FIG. 6, the notification process P may be performed after each of the first process M1, the second process M2, and the third process M3 in the software update process. Hereinafter, the notification process P performed after the first process M1 will be referred to as a first notification process P1. The notification process P performed after the second process M2 will be referred to as a second notification process P2. The notification process P performed after the third process M3 will be referred to as a third notification process P3. In FIG. 6, the same processes as those in FIG. 3 are given the same reference numerals as those in FIG. 3. In FIG. 6, some of the processes in each of the first process M1, the second process M2, and the third process M3 are not illustrated. In FIG. 6, the preliminary process L is not illustrated.

In the aspect in FIG. 6, it is assumed that the OTA master 10 performs the first process M1 and the second process M2 in the software update process when the system of the vehicle 100 is turned on, and thereafter performs the third process M3 when the system of the vehicle 100 is turned off, for example. In this case, it is considered that the OTA master 10 performs the notification processes P1, P2, and P3 at the following timings. That is, the OTA master 10 performs the first notification process P1 immediately after the first process M1. The OTA master 10 performs the second notification process P2 immediately after the second process M2. The OTA master 10 performs the third notification process P3 when the system of the vehicle 100 is switched from off to on for the first time after the third process M3 is finished. As a matter of course, the OTA master 10 also cancels the second notification process P2 when the second process M2 is canceled. Similarly, the OTA master 10 cancels the third notification process P3 when the third process M3 is canceled.

When the aspect in FIG. 6 is adopted, the contents of the notification processes P1, P2, and P3 are basically the same as that of the notification process P according to the above embodiment. That is, the OTA master 10 performs the processes in the steps illustrated in FIG. 2 in the notification processes P1, P2, and P3. The exact contents of the notification processes P1, P2, and P3 may be adjusted, as appropriate, according to the stage of the update. For example, in step S50 of the first notification process P1, the OTA master 10 determines whether the download has been successful, that is, the download has been successfully completed, based on the result of the download determination in the update result information. When it is determined that the download has not been successfully completed at this time (step S50: NO), the OTA master 10 determines that the update to the update software has not been successfully completed. In this case, the OTA master 10 makes a failure notification through the processes in steps S53 and S54, as in the above embodiment. The content of the failure notification may be the same as that according to the above embodiment. When it is determined that the download has been successfully completed (step S50: YES), on the other hand, the OTA master 10 makes a success notification in steps S51 and S52. At this time, when generating a success image in step S51, the OTA master 10 may generate a message saying that the download has been successful, in place of a message saying that software update has been completed.

In step S50 of the second notification process P2, as in the first notification process P1, the OTA master 10 determines whether the installation has been successful, that is, the installation has been successfully completed, based on the result of the installation determination in the update result information. When it is determined that the installation has not been successfully completed at this time (step S50: NO), the OTA master 10 determines that the update to the update software has not been successfully completed. Then, the OTA master 10 makes a failure notification. The content of the notification process P according to the above embodiment may be applied, as it is, to the third notification process P3. In the aspect in FIG. 6, a failure notification is made when a failure has occurred in the download, the installation, etc.

When the aspect in FIG. 6 is adopted, the processes in steps S51 and S52 may be removed in the notification processes P1, P2, and P3. That is, even when the download, the installation, etc. has been successful, a notification of such success is canceled. Such an aspect may be adopted in one or more of the three notification processes P1, P2, and P3.

When the notification process P is performed only once after the first process M1, the second process M2, and the third process M3 in the software update process as in the above embodiment, the processes in steps S51 and S52 may be removed in the notification process P.

In the above embodiment, the flow of processes has been described for a case where there is only one specific control device 90 as the update target, that is, a case where only one piece of update software is transmitted from the OTA server 500 to the OTA master 10. However, a plurality of pieces of update software may be transmitted from the OTA server 500. That is, there may be a plurality of specific control devices 90 as the update target. An example of the flow of processes for this case will be described based on the aspect according to the above embodiment as a precondition.

In step S112 in FIG. 3, the OTA server 500 transmits a plurality of pieces of update software to the OTA master 10. In this case, the OTA master 10 downloads a plurality of pieces of update software in step S13 of the first process M1. In step S14, the OTA master 10 performs a first verification for each of the pieces of update software. In step S15, the OTA master 10 generates update result information for each of the specific control devices 90 for which update is to be performed. After that, the OTA master 10 performs the second process M2 for each of the specific control devices 90 as the update target. At this time, the OTA master 10 performs a plurality of second processes M2 concurrently. After the second processes M2 are performed, the OTA master 10 performs the third process M3 for each of the specific control devices 90 as the update target. Also at this time, the OTA master 10 performs a plurality of third processes M3 concurrently.

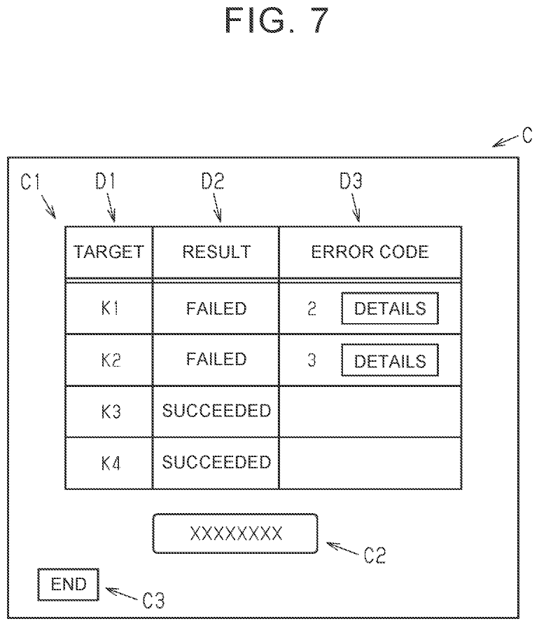

When the software update process is performed for a plurality of specific control devices 90 as described above, it is conceivable to adopt the following aspect as the notification process P. First, the OTA master 10 makes a completion determination as to whether update has been successfully completed for each of the specific control devices 90 as the update target. The OTA master 10 makes a completion determination based on the update result information on each of the specific control devices 90. The manner of the completion determination may be the same as that according to the above embodiment. When a completion determination is made for each of the specific control devices 90 as the update target, the OTA master 10 generates a summary image C such as that illustrated in FIG. 7. The OTA master 10 generates a summary image C based on the update result information on each of the specific control devices 90. The summary image C includes the following plurality of display contents. A first display content C1 is a success/failure table. The success/failure table indicates whether the update has succeeded or failed for each of the specific control devices 90 as the update target. That is, information on the same specific control device 90 is indicated in the same row of the success/failure table. A first column D1 of the success/failure table indicates the name of an in-vehicle device to be controlled by the specific control device 90. A second column D2 of the success/failure table indicates whether the update has succeeded or failed. A third column D3 of the success/failure table indicates the stage in which a failure has occurred in the update using an error code for specific control devices 90 for which a failure has occurred in the update. In the third column D3, a details button is provided next to the error code. The details button is a button that allows the user to provide an instruction to display an image for detailed information on the failure in the update, as in the above embodiment. That is, the OTA master 10 generates a detail image that is similar to the second image B according to the above embodiment for each of the specific control devices 90 for which a failure has occurred in the update, separately from the summary image C. The detail image does not include the fourth display content B4 illustrated in FIG. 5, that is, a message that provides guidance on taking the vehicle to a maintenance factory or retrying the update. Instead, the summary image C includes a message that provides guidance on taking the vehicle to a maintenance factory or retrying the update, provided in a second display content C2. The OTA master 10 determines which of guidance on taking the vehicle to a maintenance factory and guidance on retrying the update to provide in consideration of the update result information on all the specific control devices 90 as the update target. The summary image C includes an end button that functions similarly to that according to the above embodiment as a third display content C3.

When the summary image C such as that described above is generated, the OTA master 10 transmits an instruction signal for displaying the summary image C to the display 50. The display 50 displays the summary image C in response to this instruction signal. After that, the OTA master 10 switches the content to be displayed on the display 50 between the summary image C and the detail image for each of the specific control devices 90 in response to an operation performed by the user on the display 50. Causing the display 50 to display the summary image C or the detail image corresponds to making a failure notification. The OTA master 10 causes the display 50 to end display of the image when the user operates the end button in such images. At the same time, the OTA master 10 ends the notification process P.

The manner of making a failure notification indicating that a failure has occurred in the update is not limited to use of the display 50. For example, a failure notification may be made using a speaker provided in the vehicle 100. A failure notification may be made through voice guidance. Also in this case, the failure notification may include information that indicates the stage in which a failure has occurred in the update.

As described in relation to the modification of the display content of a failure image, non-volatile memories of the single-bank structure may be adopted as the non-volatile memories of the specific control devices 90. Regarding such a case, non-volatile memories of the double-bank structure may be adopted as the non-volatile memories of some of the specific control devices 90, and non-volatile memories of the single-bank structure may be adopted as the non-volatile memories of the remaining specific control devices 90.

Non-volatile memories of different structures may be adopted for a first memory and a second memory of an identical specific control device 90.

A single non-volatile memory may be used for both a first memory and a second memory of an identical specific control device 90.

The above modification regarding the non-volatile memories is also applicable to the OTA master 10. That is, non-volatile memories of the single-bank structure may be adopted as the non-volatile memories of the OTA master 10. Non-volatile memories of different structures may be adopted for the first memory 21 and the second memory 22. A single non-volatile memory may be used for both the first memory 21 and the second memory 22.

The OTA master 10 may update software for the OTA master 10 itself in the software update process. That is, the electronic control device as the target for software update by the OTA master 10 may be the OTA master 10 itself.

The overall configuration of the vehicle 100 is not limited to the example according to the above embodiment. For example, the vehicle 100 may be a so-called battery electric vehicle that does not include an engine as a drive source for the vehicle 100.

The OTA master 10 may include a processing circuit that includes one or more processors that execute various processes according to a computer program (software). The OTA master 10 may include a processing circuit that includes one or more dedicated hardware circuits such as application specific integrated circuits (ASICs), or a processing circuit that includes a combination of the processors and the dedicated hardware circuits, that executes at least a part of the various processes. The processor includes a CPU and a memory such as a random access memory (RAM) and a read only memory (ROM). The memory stores a program code or an instruction configured to cause the CPU to execute a process. The memory, that is, a computer-readable medium, includes any available medium that is accessible by a general-purpose or special-purpose computer. The present modification is also applicable to the specific control devices 90.

### APPENDIX

The above embodiment and modifications include configurations described in the following appendices.

### Appendix 1

A vehicle information processing device that performs download by receiving update software for an electronic control device mounted on a vehicle; performs installation by causing the electronic control device to store the downloaded update software; performs activation by validating the installed update software; and makes a notification of which stage among the download, the installation, and the activation a trouble has occurred in when update to the update software is not successfully completed, assuming that the update to the update software is completed when all of the download, the installation, and the activation are completed.

### Appendix 2

The vehicle information processing device according to Appendix 1, in which the notification includes information that indicates the electronic control device for which the update to the updated software is not successfully completed.

### Appendix 3

The vehicle information processing device according to Appendix 1 or Appendix 2, in which: a verification as to whether the update software is compatible with the vehicle is performed when the update to the update software is performed; and the notification includes information that indicates a result of the verification.

### Appendix 4

The vehicle information processing device according to any one of Appendix 1 to Appendix 3, in which: a capacity determination to determine presence or absence of a shortage in storage capacity necessary for the update is made when the update to the update software is performed; and the notification includes information that indicates a result of the capacity determination.

### Appendix 5

The vehicle information processing device according to any one of Appendix 1 to Appendix 4, in which the notification includes information that indicates a state of a battery mounted on the vehicle when the update to the update software is performed.

### Appendix 6

The vehicle information processing device according to any one of Appendix 1 to Appendix 5, in which the notification is made using an error code allocated in advance to each of the download, the installation, and the activation.

What is claimed is:

1. A vehicle information processing device comprising a processor configured to
perform download by receiving update software for an electronic control device mounted on a vehicle;
perform installation by causing the electronic control device to store the update software;
perform activation by validating the update software; and
make a notification of which stage among the download, the installation, and the activation a trouble has occurred in when update to the update software is not successfully completed, wherein the update to the update software is completed when all of the download, the installation, and the activation are completed.

2. The vehicle information processing device according to claim 1, wherein the notification includes information that indicates the electronic control device for which the update to the updated software is not successfully completed.

3. The vehicle information processing device according to claim 1, wherein:
the processor is configured to perform a verification as to whether the update software is compatible with the vehicle when the update to the update software is performed; and
the notification includes information that indicates a result of the verification.

4. The vehicle information processing device according to claim 1, wherein:
the processor is configured to make a capacity determination to determine presence or absence of a shortage in storage capacity necessary for the update when the update to the update software is performed; and
the notification includes information that indicates a result of the capacity determination.

5. The vehicle information processing device according to claim 1, wherein the notification includes information that indicates a state of a battery mounted on the vehicle when the update to the update software is performed.

6. The vehicle information processing device according to claim 1, wherein the processor is configured to make the notification using an error code allocated in advance to each of the download, the installation, and the activation.

7. A non-transitory storage medium storing instructions executable by one or more processors of a vehicle including an electronic control device and the one or more processors which controls update of software for the electronic control device, the instructions causing the one or more processors to perform functions comprising:
performing download by receiving update software for the electronic control device;
performing installation by causing the electronic control device to store the update software;
performing activation by validating the update software; and
making a notification of which stage among the download, the installation, and the activation a trouble has occurred in when update to the update software is not successfully completed, wherein the update to the update software is completed when all of the download, the installation, and the activation are completed.
